(19) United States
(12) Patent Application Publication
(10) Pub. No.: US 2017/0163979 A1
(43) Pub. Date: Jun. 8, 2017

(54) TESTING DEVICE OF DISPLAY DEVICES AND TESTING METHOD THEREOF

(71) Applicant: AmTRAN TECHNOLOGY CO.,LTD, New Taipei City (TW)

(72) Inventor: Chih-Chin FAN, New Taipei City (TW)

(21) Appl. No.: 15/080,013

(22) Filed: Mar. 24, 2016

(30) Foreign Application Priority Data
Dec. 4, 2015 (TW) 104140820

(51) Int. Cl. H04N 17/02; G01J 5/60

(52) U.S. Cl. CPC H04N 17/02; G01J 5/60; G01J 2005/608

(57) ABSTRACT

A testing device of display devices and a testing method thereof are disclosed. The testing device includes a first connecting interface, a processing module, and a memory module. The first connecting interface is pluggable and is connected to the display device. The processing module is electrically connected to the first connecting interface. The processing module provides the information of test items stored in the memory module to the display device through the first connecting interface when the testing device and the display device are being transported on a production line, so the display device performs an operation procedure according to the information of test items. The processing module generates a test result according to the operation procedure executed by the display device and stores the test result in the memory module.

### CROSS-REFERENCE TO RELATED APPLICATIONS

This non-provisional application claims priority under 35 U.S.C. §119(a) on Patent Application No(s). 104140820 filed in Taiwan, R.O.C. on Dec. 4, 2015, the entire contents of which are hereby incorporated by reference.

### BACKGROUND

Technical Field

The disclosure relates to a testing device and a testing method thereof for display devices, more particularly to a testing device for testing display devices on the production line, and to a testing method thereof.

Related Art

Generally, display devices are subjected to a variety of software test, firmware tests and function tests to ensure the quality of each display device after being assembled on the production line. In the conventional testing method, display devices are put in a testing station on a production line, so each of the display devices is conveyed on a conveyer belt to in turn stop at each of the control points in the testing stations for a respective testing items and processes.

When a display device arrives at a testing station, a testing process, which the display device is going through, usually takes some time. Also, there is certain distance from one two testing station to another testing station. Therefore, whenever the display device is on the way to a next testing station, the display device will be idle and not being tested. Because the power supply for display device is continuously on during the transportation, if the display device is idle during the co transportation, it will cause a waste of power so that lower efficiency of testing.

### SUMMARY

The disclosure provides a testing device of display devices and a testing method thereof in order to prevent display devices in a testing station from the power wastes and lower test efficiency, caused by the idleness of the display devices.

According to one or more embodiments, the disclosure provides a testing method applied to a testing device that is pluggable and is connected to a display device. The testing method includes the following steps: providing the display device with the information of test items stored in the testing device when the testing device and the display device are being transported on a production line so the display device performs an operation procedure according to the information of test items; generating a test result according to the operation procedure performed by the display device; and storing the test result.

According to one or more embodiments, the disclosure provides a testing device that is pluggable and is connected to a display device. The testing device includes a first connecting interface, a processing module and a memory module. The first connecting interface is pluggable and is connected to the display device, and the processing module is electrically connected to the first connecting interface. The processing module provides the display device with the information of test items through the first connecting interface when the testing device and the display device are being transported on a production line, so the display device executes an operation procedure according to the information of test items. The processing module generates a test result according to the operation procedure executed by the display device. The memory module stores the information of test items and the test result.

In view of the above testing device and the testing method in the disclosure, the testing device is carried with the display device on the production line after the testing device is electrically connected to the display device; and when the testing device and the display device are being transported on the production line, the testing device sends the display device a test command so that testing the display device can be continued while the display device is being transported. Therefore, the display device does not need to waste time idling on the testing stations, the power consumption may reduce, and the test efficiency may enhance.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of a testing station in which display devices are being conveyed on a production line in an embodiment;

FIG. 2 is a block diagram of a testing device in an embodiment;

FIG. 3 is a schematic view of a testing station in which display devices are being transported on a production line in another embodiment;

FIG. 4 is a block diagram of a testing device in another embodiment;

FIG. 5 is a schematic view of a testing station in which display devices are being transported on a production line in yet another embodiment;

FIG. 6 is a block diagram of a testing device in yet another embodiment;

FIG. 7 is a schematic view of a testing station in which display devices are being transported on a production line in yet another embodiment;

FIG. 8 is a block diagram of a testing device in yet another embodiment;

FIG. 9 is a flow chart of a testing method in an embodiment;

FIG. 10 is a flow chart of a testing method in another embodiment; and

FIG. 11 is a flow chart of a testing method in yet another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

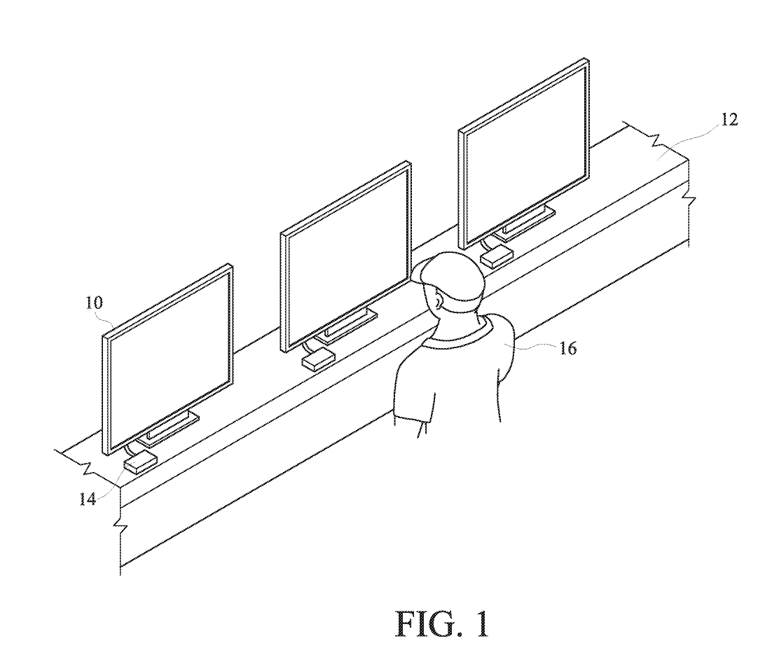

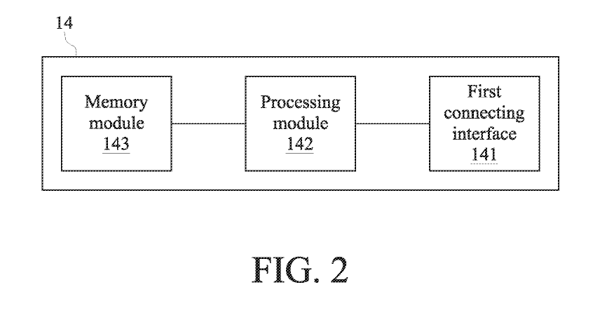

Please refer to FIG. 1 and FIG. 2. FIG. 1 is a schematic view of a testing station in which display devices are being transported on a production line in an embodiment, and FIG. 2 is a block diagram of a testing device in an embodiment. In the figures, multiple display devices 10 are put in a testing station 12 after being assembled, so the display devices 10 will be transported on a conveyer belt for the testing processes at the control points 16. The testing device 14 is electrically connected to the display devices 10 and includes a first connecting interface 141, a processing module 142 and a memory module 143. The testing device 14 is electrically connected to the display device 10 through the first connecting interface 141. The first connecting interface 141 includes, but not limited to, a USB interface, a high definition multimedia interface (HDMI) or other suitable connecting interfaces. The first connecting interface 141 is pluggable and is connected to the display device 10. In this embodiment, for the purpose of concise presentation, only one connection wire is used to connect the testing device 14 to the display device 10, but the disclosure has no limitation in the number of connection wires used by the testing device 14. Moreover, the position of test personnel in the figure is used to represent the position of the control point 16 rather than is used to restrict the control point 16 to necessarily rely on the test personnel to execute its testing process on the display devices 10.

The processing module 142, through the first connecting interface 141, provides the display device 10 with the information of test items stored in the memory module 143 when the testing device 14 and the display device 10 are being transported on the production line. Therefore, the display device 10 executes an operation procedure according to the information of test items, and the processing module 142 generates a test result according to the operation procedure executed by the display device 10 and stores the test result in the memory module 143. In practice, the processing module 142 has storage for storing operation software, and when the testing device 14 is turned on, the processing module 142 will execute a related testing process through the operation software. In an embodiment, the operation software used to execute the testing process by the processing module 142 is conformed to Linux®, Unix®, Microsoft Windows® or another suitable operating system. In another embodiment, the processing module 142 is carried out by, for example, but not limited to, a programmable logic controller (PLC), a complex programmable logic controller (CPLC), a field-programmable gate array (FPGA) or another suitable hardware.

In an embodiment, when the display device 10 is disposed in the testing station 12 and is going through a testing process, the testing station 12 will power the display device 10 for one or more testing tasks. The testing device 14, which is electrically connected to the display device 10, may obtain electricity from the display device 10. For example, when the testing device 14 is electrically connected to the display device 10 through the USB connecting interface, the display device 10 may supply an about 5V voltage to the testing device 14. Instances of the test items, executed by the processing module 142 to test the display device 10, include the testing of wireless transmission, the testing of start up and shut down, the testing of image display, the testing of audio playback or the testing of other functions, and some of these instances will be described below.

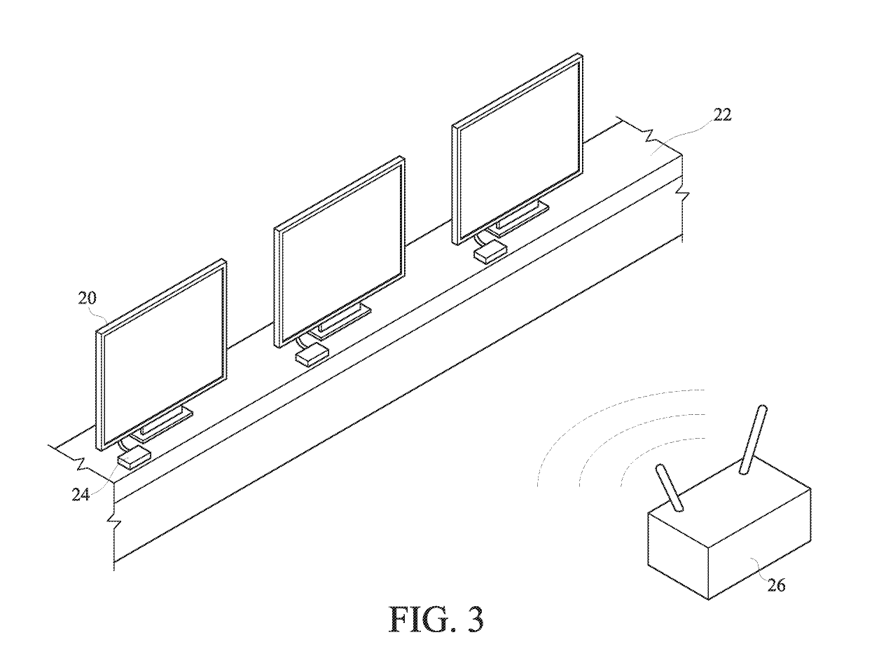

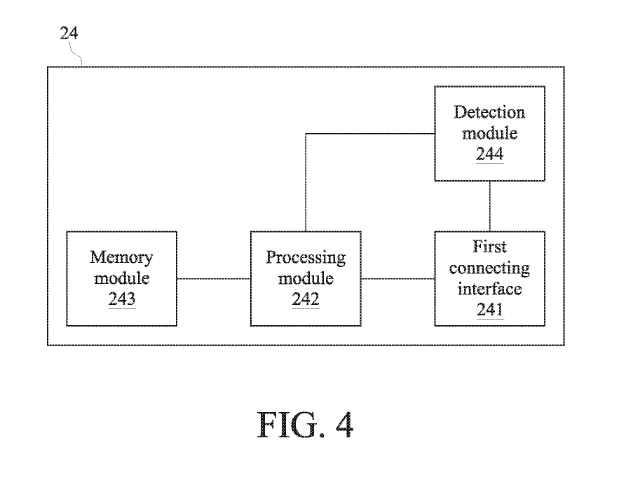

Please refer to FIG. 3 and FIG. 4. FIG. 3 is a schematic view of a testing station in which display devices are being transported on a production line in another embodiment, and FIG. 4 is a block diagram of a testing device in another embodiment. In this embodiment, as shown in the figures, multiple display devices 20 are similarly being transported on a conveyer belt for the testing process at the control points. Each of the display devices 20 is electrically connected to a testing device 24, and each of the testing devices 24 includes a first connecting interface 241, a processing module 242, a memory module 243 and a detection module 244. The testing device 24 is pluggable and is connected to the display device 20 through the first connecting interface 241.

The processing module 242, through the first connecting interface 241, provides the display device 20 with the information of test items stored in the memory module 243 when the testing device 24 and the display devices 20 are being transported on a production line. The information of test items includes the wireless network connection information, according to which the display device 20 can wirelessly connect to one or more access points. The wireless network connection information is, for example, but not limited to, the service set identifier (SSID), IP address or other connection information of an access point 26. The display device 20 may search for the access point 26 and wirelessly connects to the access point 26 successfully according to the SSID or IP address of the access point 26 or the media access control address (MAC) of a wireless network module (e.g. a Wi-Fi module) in the display device 20 or other connection information. When the display device 20 connects to the access point 26, the access point 26 may provide the display device 20 with a test signal, so the display device 20 may execute an operation procedure, e.g. connecting to one or more wireless network access points, or displaying one or more image files, or outputting one or more audio files, or displaying one or more test images or other operation procedures, related to the test signal. When the display device 20 executes the operation procedure indicated by the test signal, the detection module 244 determines the test result of the display device 20 against the wireless transmission function of the display device 20 according to the output signal generated by the first connecting interface 241 executing the test signal.

For example, the test signal provided by the access point 26 is multimedia information, which is used by the display device 20 to display one or more images, output one or more sounds or another multimedia output action. Herein, when the display device 20 is outputting the images or sounds corresponding to the multimedia information, the detection module 244 will detect operation signals, e.g. signals in data scan lines of a display panel, input signals of a loudspeaker or signals of other portions in the display device, in the display device 20 through the first connecting interface 241. Then, the detection module 244 sends the detection result to the processing module 242, so the processing module 242 determines the signal intensity or noise level of data, wirelessly received by the display device 20, according to the detection result and considers the determination result as the test result of the display device 20 regarding the ability of wireless transmission.

In a practical example, the first connecting interface 241 includes an USB interface and a HDMI interface, so the testing device 24 can obtain the electricity supplied by the display device 20 through the USB interface. Also, the processing module 242 provides the information of test items to the display device 20 through the USB interface. The detection module 244, through the HDMI interface, detects a signal of multimedia information outputted in the display device 20. However, this embodiment is not restricted to this example. In an embodiment, after receiving the detection result from the detection module 244, the processing module 242 may compare the detection result with a preset threshold to determine whether the signal strength or noise level of data, wirelessly received by the display device 20, meets its quality request, and the processing module 242 sets the determination result as a test result and stores it in the memory module 243.

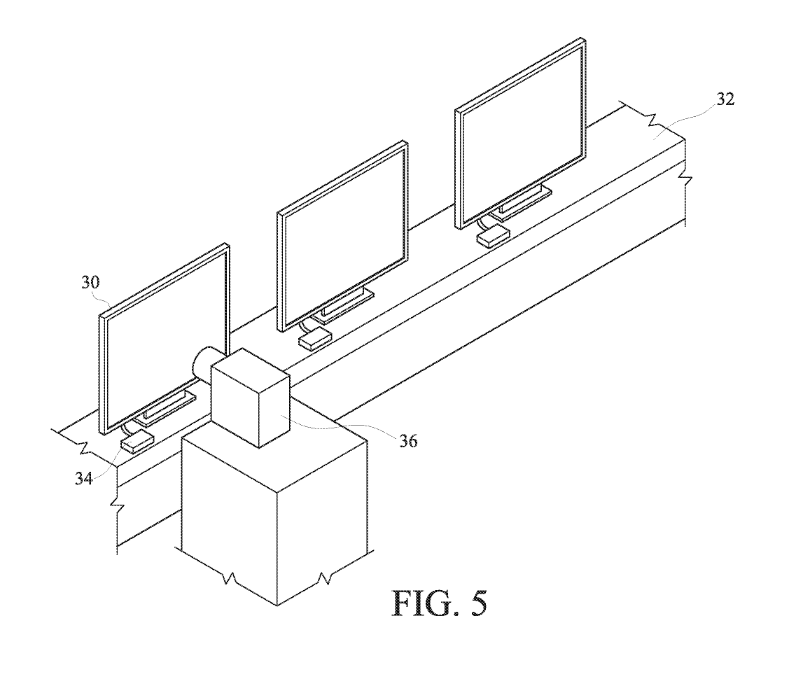

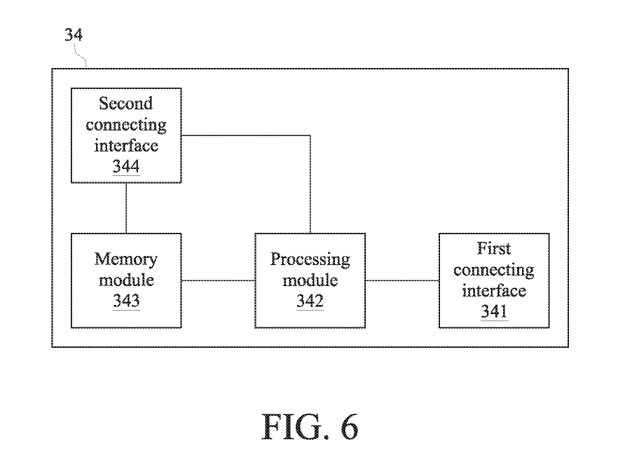

Please refer to FIG. 5 and FIG. 6. FIG. 5 is a schematic view of a testing station in which display devices are being transported on a production line in yet another embodiment, and FIG. 6 is a block diagram of a testing device in yet another embodiment. Different from the previous embodiment, each testing device 34 includes a first connecting interface 341, a processing module 342, a memory module 343 and a second connecting interface 344. Similarly, the testing device 34 is pluggable and is connected to a display device 30 through the first connecting interface 341, so the testing device 34 and the display device 30 are transported together in a testing station 32 on a production line.

When the testing device 34 and the display device 30 are being transported on the production line, the processing module 342, through the first connecting interface 341, provides the display device 30 with the information of test items stored in the memory module 343. The information of test items is, for example, commanding the display device 30 to display a white screen or other test images with different color temperatures. When the display device 30 displays a white screen according to the information of test items, the processing module 342 may request a color temperature analyzer 36 via the second connecting interface 344 to perform a color temperature analysis to the test image displayed by the display device 30 in order to check the image display function of the display device 30. The color temperature analyzer 36 stores the analysis result in the memory module 343 through the second connecting interface 344. In another embodiment, the color temperature analyzer 36 outputs the analysis result to the processing module 342 through the second connecting interface 344, and then the processing module 342 determines whether the analysis result provided by the color temperature analyzer 36 is standard, and stores the determination result as a test result in the memory module 343.

In addition to the above multimedia information and a command for controlling the display device 30 to display a white screen or other test images with different color temperatures, the information of test item may be one or more test images or one or more test sounds, which are stored in the testing device and are outputted to the display device 30 by the testing device, for testing the image display function or audio playback function of the display device 30.

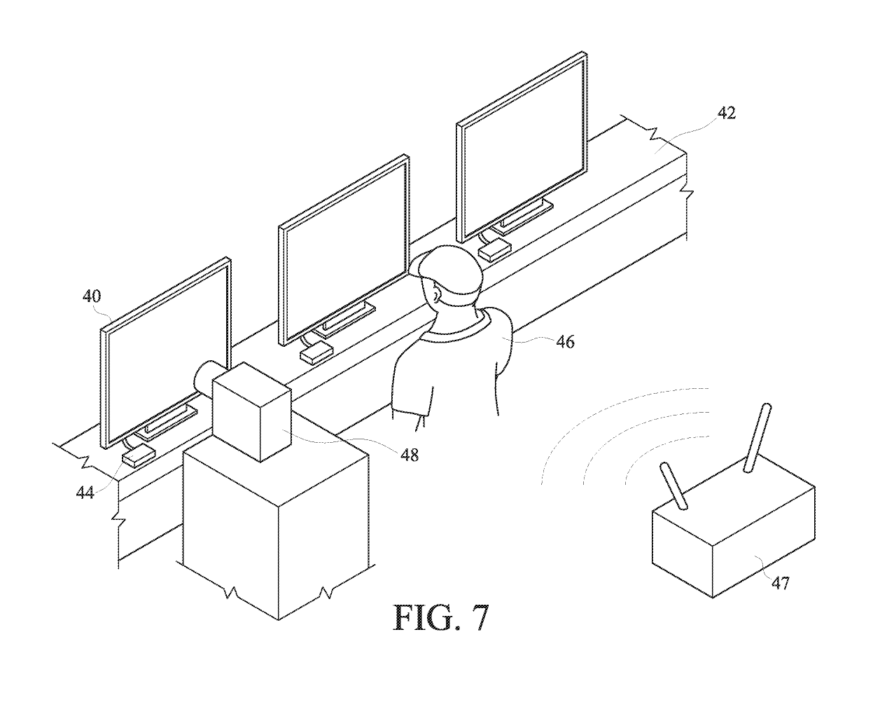

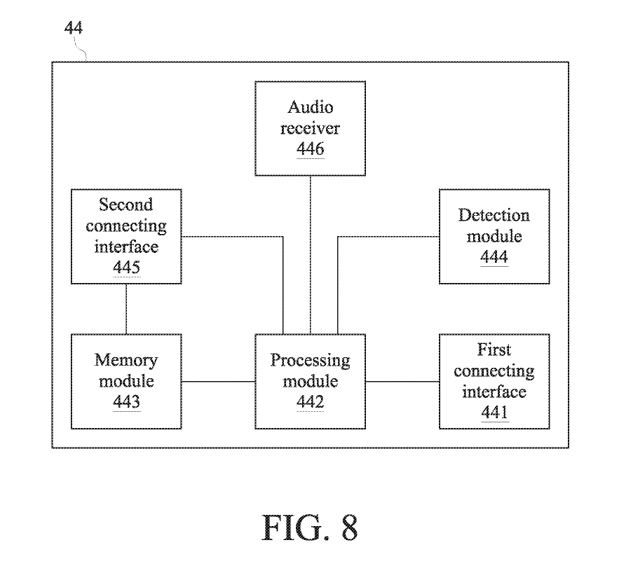

Then, please refer to FIG. 7 and FIG. 8. FIG. 7 is a schematic view of a testing station in which display devices are being transported on a production line in yet another embodiment, and FIG. 8 is a block diagram of a testing device in yet another embodiment. Different from the previous embodiment, a testing device 44, as shown in the figures, includes a first connecting interface 441, a processing module 442, a memory module 443, a detection module 444, a second connecting interface 445 and an audio receiver 446. Similarly, the testing device 44 similarly is pluggable and is connected to a display device 40 through the first connecting interface 441, so the testing device 44 and the display device 40 are transported in a testing station 42 on a production line together.

The processing module 442 provides the wireless network connection information, stored in the memory module 443, to the display device 40 through the first connecting interface 441 when the testing device 44 and the display device 40 are being transported on the production line, so the display device 40 searches for an access point 47 according to the wireless network connection information and connects to the access point 47. When the display device 40 receives the multimedia information from the access point 47, the display device 40 may display the one or more test images in the multimedia information, play the one or more test sounds in the multimedia information, or execute other multimedia output procedures.

In this embodiment, when the display device 40 executes the multimedia output procedure, the detection module 444, an audio receiver 446 and a camera 48 are used to test various functions of the display device 40. Specifically, the detection module 444, through the first connecting interface 441, detects one or more output signals of the display device 40 executing multimedia, for detecting the ability of wireless transmission of the display device 40.

The audio receiver 446 may be disposed on the testing device 44 or in the testing station 42 or another suitable place. The audio receiver 446 detects test sounds outputted by the display device 40 to generate an audio test result. The audio receiver 446 sends the audio test result to the processing module 442, so the processing module 442, according to the audio test result, determines the test result of the display device 40 regarding the ability of audio playback. For example, the audio receiver 446 detects the output effect, sound effect of left and right channels, and the noise level of test sounds having a frequency ranging from 0 hertz to 3000 hertz.

In another embodiment, the testing device 44 provides other audio files stored in the memory module 443 to the display device 40, and the testing device 44 commands the display device 40 to switch its output audio source to another one and play the audio files provided by the testing device 44, so as to test the audio playback function of the display device 40 for other audio sources.

Moreover, the camera 48 is disposed in the testing station 42 or another suitable place, for example. The camera 48 records test images displayed by the display device 40, so the processing module 442, according to the records (i.e. the photographing result) of the camera 48, determines the test result of the display device 40 regarding the ability of image display. For instance, the processing module 442 analyzes the resolution, hue, saturation, brightness, noise level and white balance of images displayed by the display device 40, according to the records made by the camera 48. Similarly, in another embodiment, the testing device 44 provides other image files, stored in the memory module 443, to the display device 40 and commands the display device 40 to switch its output image source and display the image files provided by the testing device, so as to test the image display function of the display device 40 for other image sources.

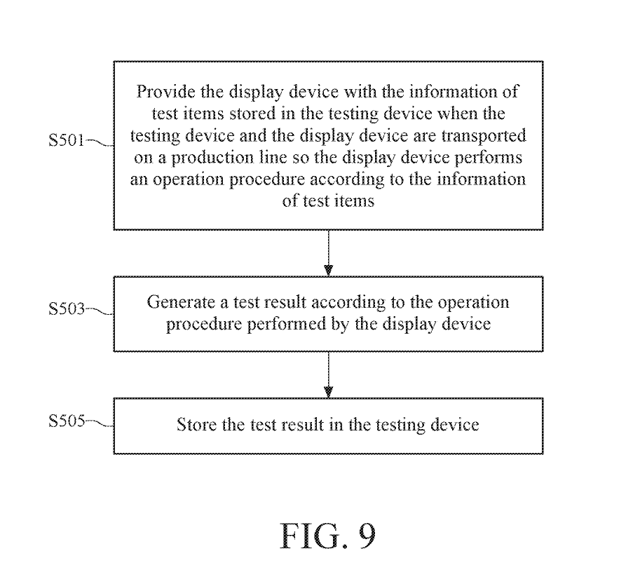

To more clarify the testing method, please refer to FIG. 1 and FIG. 9. FIG. 9 is a flow chart of a testing method in an embodiment. As shown in the figures, the testing method includes the following steps. In step S501, when the testing device 14 and the display device 10 are being transported on a production line, the information of test items stored in the testing device 14 is provided to the display device 10, so the display device 10 executes an operation procedure according to the information of test items. In step S503, the testing device 14 generates a test result according to the operation procedure executed by the display device 10. In step S505, this test result is stored in the testing device 14. The details of the method have been described in above embodiments and thus, will not be repeated hereinafter.

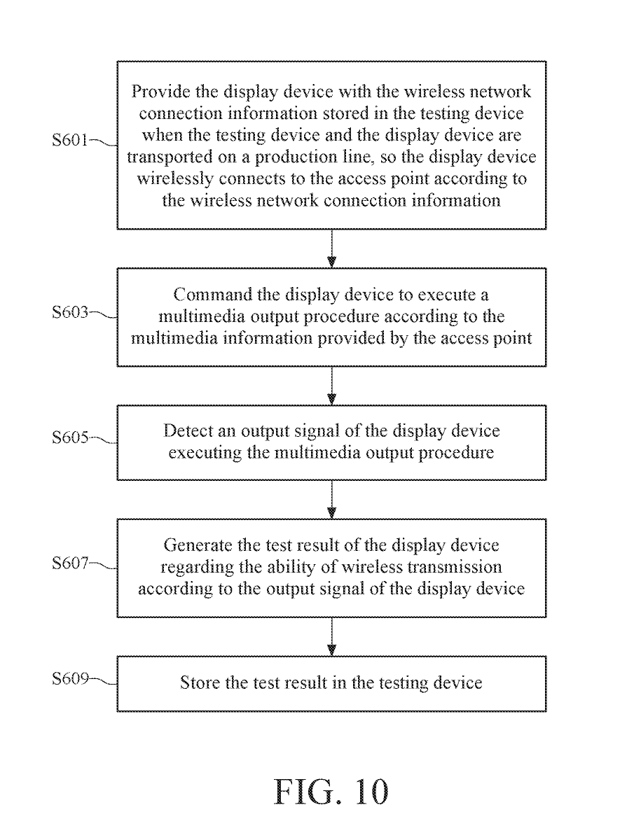

In another embodiment, please refer to FIG. 3 and FIG. 10. FIG. 10 is a flow chart of a testing method in another embodiment. As shown in the figures, the testing method includes the following steps. In step S601, when the testing device 24 and the display device 20 are being transported on a production line, the wireless network connection information stored in the testing device 24 is provided to the display device 20, so the display device 20 connects to the access point 26 according to the wireless network connection information. In step S603, the display device 20 is commanded to execute a multimedia output procedure according to the multimedia information provided by the access point 26. In step S605, the output signal of the display device 20 executing the multimedia output procedure is outputted. In step S607, a test result of the display device 20 regarding the ability of wireless transmission is produced according to the output signal of the display device 20. In step S609, this test result is stored in the testing device 24. The details of the method have been described in above embodiments and thus, will not be repeated hereinafter.

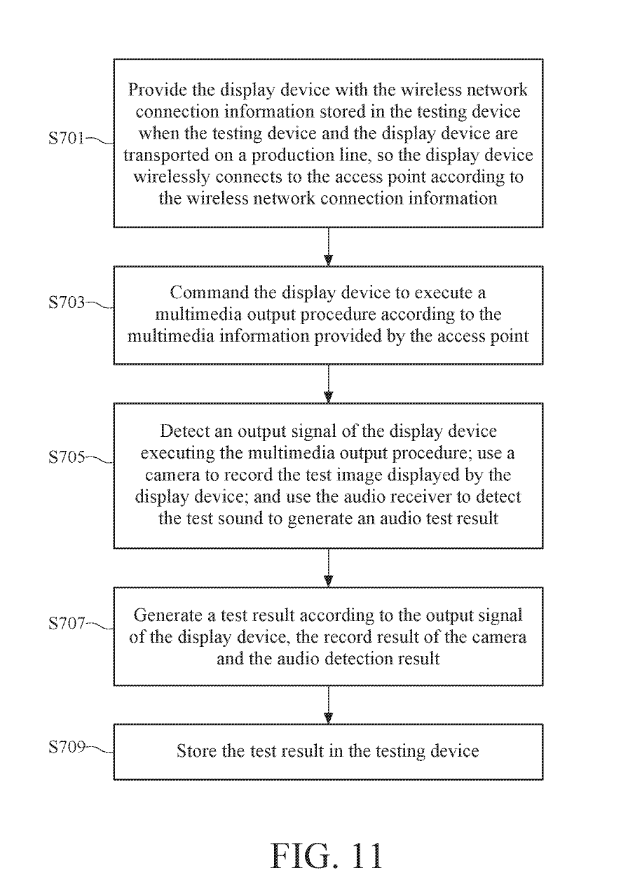

Also, please refer to FIG. 7, FIG. 8 and FIG. 11. FIG. 11 is a flow chart of a testing method in yet another embodiment. As shown in the figures, the testing method includes the following steps. In step S701, when the testing device 44 and the display device 40 are being transported on a production line, the wireless network connection information stored in the testing device 44 is provided to the display device 40, so the display device 40 connects to the access point 47 according to the wireless network connection information. In step S703, the display device 40 is commanded to execute a multimedia output procedure according to the multimedia information provided by the access point 47. In step S705, the output signal of the display device 40 executing the multimedia output procedure is detected, the camera 48 is used to record the test image displayed by the display device 40, and the audio receiver 446 is used to detect test sounds to generate an audio test result. In step S707, a test result is generated according to the output signal of the display device 40, records made by the camera 48 and the audio test result. In step S709, this test result is stored in the testing device 44.

As set forth above, the disclosure provides a testing device and a testing method for display devices, and the display device and the testing device are transported together at a station on a production line after the testing device is electrically connected to the display device. Herein, when the display device is being transported on the production line, the testing device may send a test command to the display device for the continuous testing. Therefore, the display device does not need to waste time idling at the testing stations, the power consumption may reduce, the test efficiency may enhance, and the amount of failures in the automated test process may be less than an artificial test.

1. A testing method applied to a testing device that is pluggable and is connected to a display device, the testing method comprising:
providing the display device with information of test items stored in the testing device when the testing device is being transported with the display device on a production line so the display device performs an operation procedure according to the information of test items;
generating a test result according to the operation procedure performed by the display device; and
storing the test result in the testing device.

2. The testing method according to claim 1, wherein the information of test items comprises wireless network connection information;
the display device connects to an access point according to the wireless network connection information; and
generating the test result according to the operation procedure comprises:
commanding the display device to execute a multimedia output procedure according to multimedia information provided by the access point;
detecting an output signal of the display device executing the multimedia output procedure; and
determining the test result of the display device regarding an ability of wireless transmission according to the output signal of the display device.

3. The testing method according to claim 2, wherein commanding the display device to execute the multimedia output procedure comprises:
commanding the display device to display a test image according to the multimedia information; and
the testing method further comprises:
by a camera recording the test image displayed by the display device; and
determining the test result of the display device regarding an ability of image display according to photographing result of the camera.

4. The testing method according to claim 2, wherein commanding the display device to execute the multimedia output procedure comprises:
outputting a test sound according to the multimedia information; and
the testing method further comprises:
by an audio receiver detecting the test sound to generate an audio test result; and
determining the test result of the display device regarding an ability of audio playback according to the audio test result.

5. The testing method according to claim 1, wherein the information of test items comprises commanding the display device to display a test image; and
generating the test result according to the operation procedure performed by the display device comprises:
by a color temperature analyzer analyzing the test image displayed by the display device; and
determining the test result of the display device regarding an ability of image display according to analysis result of the color temperature analyzer.

6. A testing device of displays, comprising:
a first connecting interface that is pluggable and is connected to a display device;
a processing module electrically connected to the first connecting interface and configured to provide the display device with information of test items through the first connecting interface when the testing device is being transported with the display device on a production line, so the display device executes an operation procedure according to the information of test items, the processing module also configured to generate a test result according to the operation procedure executed by the display device; and
a memory module configured to store the information of test items and the test result.

7. The testing device according to claim 6, wherein the information of test items, provided by the processing module, comprises wireless network connection information, according to which the display device connects to an access point;
the testing device further comprises:
a detection module electrically connected to the processing module and configured to detect an output signal of the display device through the first connecting interface when the processing module commands the display device to execute a multimedia output procedure according to multimedia information provided by the access point; and
the processing module determines the test result of the display device regarding an ability of wireless transmission according to detection result of the detection module.

8. The testing device according to claim 7, wherein when the display device is executing the multimedia output procedure, the display device displays a test image according to the multimedia information;
the testing device further comprises:
a second connecting interface configured to receive a photographing result of a camera recording the test image displayed by the display device; and
the processing module determines the test result of the display device regarding an ability of image display according to the photographing result of the camera.

9. The testing device according to claim 7, wherein when the display device is executing the multimedia output procedure, the display device outputs a test sound according to the multimedia information; and
the processing module determines the test result of the display device regarding an ability of audio playback according to an audio test result, which is generated by an audio receiver detecting the test sound outputted by the display device.

10. The testing device according to claim 6, wherein the information of test items provided by the processing module comprises commanding the display device to display a test image;
the testing device further comprises:
a third connecting interface configured to receive an analysis result that a color temperature analyzer analyzes the test image displayed by the display device; and
the processing module determines the test result of the display device regarding an ability of image display according to the analysis result of the color temperature analyzer.
